(19) United States
(12) Patent Application Publication
(10) Pub. No.: US 2007/0226372 A1
(43) Pub. Date: Sep. 27, 2007

(54) Distributed Authorized Domain Management

(75) Inventors: Sjoerd Zwart, Eindhoven (NL); Robertus Cornelis Jacobus Brink, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/599,887

(22) PCT Filed: Apr. 8, 2005
(86) PCT No.: PCT/IB05/51159

§ 371 Date: Oct. 12, 2006

(30) Foreign Application Priority Data
Apr. 16, 2004 (EP) 04101569.4

(51) Int. Cl. G06F 15/16; H04N 7/00

(52) U.S. Cl. 709/248

(57) ABSTRACT

The present invention relates to an authorized domain including a plurality of Authorized Domain Managers (ADMs). The plurality of ADMs contrary to a single ADM solution enables portable ADMs, that do not have to be continuously connected to the AD. The invention provides a solution for keeping the ADMs synchronized. For this purpose, inter alia, each ADM is provided with a map, which comprises an identifier area for containing identifiers corresponding to other devices, and at least one property area for containing properties of the identifiers. The property area is mapped on the identifier area. The properties are arranged to provide information about updates thereof. By obtaining map contents of another ADM, and comparing the contents of the own map with the map contents of the other ADM, it is possible for an ADM to determine whether to perform any updates of the own map.

### FIELD OF THE INVENTION

The present invention relates to an authorized domain (AD) system, a method for managing an AD, and a device that is used as an AD manager.

### BACKGROUND OF THE INVENTION

The concept of authorized domains tries to find a solution to both serve the interests of the content owners (that want protection of their copyrights) and the content consumers (that want unrestricted use of the content). The basic principle is to have a controlled network environment in which content can be used relatively freely as long as it does not cross the border of the AD. Typically, authorized domains are centered around the home environment, also referred to as home networks. Of course, other scenarios are also possible. A user could for example take a portable television with him on a trip, and use it in his hotel room to access content stored on his Personal Video Recorder at home. Even though the portable television is outside the home network, it is a part of the user's authorized domain.

The concept of an AD is further explained by S.A.F.A. van den Heuvel, W. Jonker, F.L.A.J. Kamperman, and P. J. Lenoir, Philips Research, in “Secure Content Management In Authorized Domains”, IBC 2002 Conference paper, pp 467-474. This paper describes a model for an Authorized Domain, which comprises a plurality of devices. A device can be registered and deregistered as a part of an AD, by adding the device to or removing the device from, respectively, the AD. This AD Management is centralised, and is performed by an AD Manager (ADM). The ADM is simply one of the devices which are parts of the AD. During device registration, the device to be registered will obtain an AD key or identifier, provided that certain conditions are fulfilled. During device deregistration, the AD key or identifier in the device will be deleted.

Various systems already exist that implement the concept of authorized domains to some extent. Examples of device-based systems are SmartRight (Thomson Multimedia), xCP (4C, mainly IBM), and NetDRM (Matshushita). Further examples of device based AD are e.g. given in international patent application WO 03/098931 (attorney docket PHNL020455) and in European patent application serial number patent application 04100997.8 (attorney docket PHNL040288) by the same applicant.

Another type of previous solutions is person based Authorized Domains, where the domain is based on persons instead of devices as was the case for device based ADs. An example of such a system is e.g. described in international patent application serial number IB2003/004538 (attorney docket PHNL021063) by the same applicant, in which content is coupled to persons which then are grouped into a domain.

Hybrid person and device based authorized domains are proposed in European patent application serial number 03102281.7 (attorney docket PHNL030926) and in European patent application serial number 04101256.8 (attorney docket PHNL040315) by the same applicant.

However, the approach of a centralized ADM for an AD has a number of disadvantages, including:
In a case where the AD is limited to the home of the user the following disadvantage appears. When the user has more houses, for example when the user has a holiday residence, the ADM can only add or remove devices in one of the residences. Assuming that the AD is arranged in the home residence, and the user brings the device that is ADM to the holiday residence (or on a business trip) and buys a new device during the stay there. Then the user may wish to add the new device to the AD, which will not be possible until he/she returns to the home residence and reconnects the ADM to the AD. Likewise, some other person of the household may wish to add a new device to the AD while the ADM is disconnected, which will also not be possible. This is not a user-friendly concept.
The concept of an AD is very technical and is difficult to explain to a user. From a user point of view, the AD is only causing disadvantages and not advantages. For example, the AD is limiting the user in comparison with the unlimited situation when no AD exists. Therefore the concept should not be presented to the user, and that is true also for the concept of ADM. This is a disadvantage when only one device is an ADM. When the user wishes to add or remove a device, the ADM must be connected to the network of the Authorized Domain, otherwise the adding or removing will fail. Consequently, in a single ADM configuration, the user has to know which device is an ADM but should not have to learn about the concept of an ADM, which would be difficult to explain.
Another issue is the issue of availability. If there is only one ADM in the AD, the availability of the ADM depends on whether the device is on and connected to the network, i.e. the AD. If there would be more than one ADM, the availability of the “ADM service” would increase.

Consequently, it would be an advantage to have more than one ADM capable device, i.e. more than one device that has the capability of acting as an ADM, within the AD. There would, of course, still be a risk of all ADM devices being offline at the same time, but this risk would decrease in comparison to the configuration with only one centralized ADM.

One of the requirements for a multi-ADM solution to work properly is that all AD Managers should be able to work, and add/remove devices, without having direct contact with each others. Each AD manager should know which devices are in the AD and how many devices it can add to the AD. However, since, in the multi-ADM structure, the AD managers can be arbitrarily connected and disconnected, and devices can be added/removed at arbitrary times, there will be a problem to keep the management data on the AD managers synchronized. There is no known solution to this synchronization problem.

### SUMMARY OF THE INVENTION

It is an object with the present invention to provide a solution to the problem of keeping the AD Managers synchronized in an AD comprising a plurality of AD Managers.

This object is achieved by the invention as defined in either of claims 1, 8, 9 and 11 of the enclosed set of claims.

Thus, in one aspect thereof, the invention provides for a device for managing an authorized domain, comprising a map, which comprises an identifier area for containing identifiers corresponding to other devices, and at least one property area for containing properties of the identifiers. Said at least one property area is mapped on the identifier area, such that each individual property of said properties is mapped to an individual one of said identifiers. The properties are arranged to provide information about updates thereof. The device further comprises means for obtaining map contents of another device for managing the same authorised domain, and means for comparing the contents of the own map with said map contents of said another device, and for determining, on basis of said comparison, whether to perform any updates of the own map.

In another aspect thereof, the invention provides for a system comprising a plurality of devices interconnectable by means of a network and being arranged as an Authorized Domain, wherein at least two of said plurality of devices are acting as Authorized Domain Managers. For the purposes of this application it is to be noted that a peer-to-peer connection is also considered to be a network. Each Authorized Domain Manager is arranged in accordance with the device of the above-described first aspect.

Consequently, since map contents of the ADM maps is compared, and since the map contains, for each identifier, information about any property update the invention provides a condition for a successful synchronisation of ADMs, where the correct current information about different identifiers, i.e. devices, is exchangeable among the ADMs. The map updates, thus, comprise adding new identifiers, amending properties of existing identifiers, etc.

In accordance with an embodiment of the device, as defined in claim 2, two included property types are state and sequence number, where there are at least two types of states, and where the sequence number represents state shifts. This is one solution for tracking changes in the AD, thereby making it possible to figure out which property data is most recently updated. That information is then used for updating old property data of any ADM map. For reasons of understanding it is to be exemplified that the sequence value could be incremented every time the state changes from removed to added. That would lead to a larger sequence number in the map of an ADM that has registered more additions of the device in question than another ADM.

Thus, for example when an ADM is disconnected from the AD, such as in the vacation case described above, and a device is added to or removed from the AD, the disconnected ADM will be updated thereof after having been reconnected to the ADM by communicating with another ADM, which has stayed in the AD. It is to be noted that there are several other possible ways for the ADMs to exchange map data, as will be explained below.

In accordance with an embodiment of the device, as defined in claim 6, the operation of finding the most recent changes is performed by use of a means which checks that one or more certain conditions are met. Referring again to the vacation case, according to this embodiment, one such condition is that an identifier is missing in the map of the reconnected ADM. Another condition, according to this embodiment, is that indeed the identifier exists in the map of the reconnected ADM, but a comparison value, which is achieved by a comparison between one or more properties of the maps, indicates that the property(-ies) of the map of the ADM that has stayed in the AD is more recently updated.

According to another embodiment of the device, as defined in claim 7, which is based on the just described embodiment, in case of equal sequence numbers the states are compared, wherein the state of added and the state of removed are represented by different values. Assume, for example, that the value of “removed” is larger than the value of “added” and the sequence number is merely increased at a state change from removed to added, as in the example above, then the larger value will indicate the most recent change.

The set of states could, for example, be extended with states such as stolen, broken, revoked, etc.

In a further aspect thereof, the invention provides for a method for managing an Authorized Domain comprising a plurality of devices, wherein at least two thereof act as Authorized Domain Managers, comprising the steps of:

providing each Authorized Domain Manager with a capability of at least managing adding devices to and removing devices from the Authorized Domain;

for each Authorized Domain Manager:

arranging a map comprising an identifier area and at least one property area;
storing identifiers corresponding to other devices in the identifier area;
storing properties of the identifiers in said at least one property area;
mapping said at least one property area on said identifier area, such that each individual property of said properties is mapped to an individual one of said identifiers;
arranging said properties so as to provide information about updates thereof;
obtaining map contents of another Authorized Domain Manager managing the same authorised domain;
comparing the contents of the own map with said map contents of said another Authorized Domain Manager; and
determining, on basis of said comparison, whether to perform any updates of the own map. In a further aspect thereof, the invention provides for a computer program product, directly loadable into the internal memory of a digital computer, comprising software code portions for causing the computer to act as an Authorized Domain Manager, being capable of at least managing adding devices to and removing devices from an Authorized Domain, and for causing the computer to perform the steps of:
arranging a map comprising an identifier area and at least one property area;
storing identifiers, corresponding to devices, in the identifier area;
storing properties of the identifiers in said at least one property area;
mapping said at least one property area on said identifier area, such that each individual property of said properties is mapped to an individual one of said identifiers;
arranging said properties so as to provide information about updates thereof,
obtaining map contents of another Authorized Domain Manager managing the same authorised domain;
comparing the contents of the own map with said map contents of said another Authorized Domain Manager; and
determining, on basis of said comparison, whether to perform any updates of the own map.

From the above discussion regarding the device and system it is evident that the steps performed in accordance with the method and the computer program product, respectively, will provide for similar solutions and advantages.

These and other aspects of the invention will be apparent from and elucidated with reference to the embodiments described hereinafter.

### BRIEF DESCRIPTION OF THE DRAWINGS

The invention will now be described in more detail and with reference to the appended drawings in which:

FIG. 1 shows an example of an Authorized Domain;

FIG. 2 is a block diagram of an embodiment of a device acting as an Authorized Domain Manager in accordance with the present invention;

FIG. 3 shows an embodiment of a map according to this invention; and

FIG. 4 is a block diagram illustrating different solutions for map handling according to the present invention.

### DESCRIPTION OF PREFERRED EMBODIMENTS

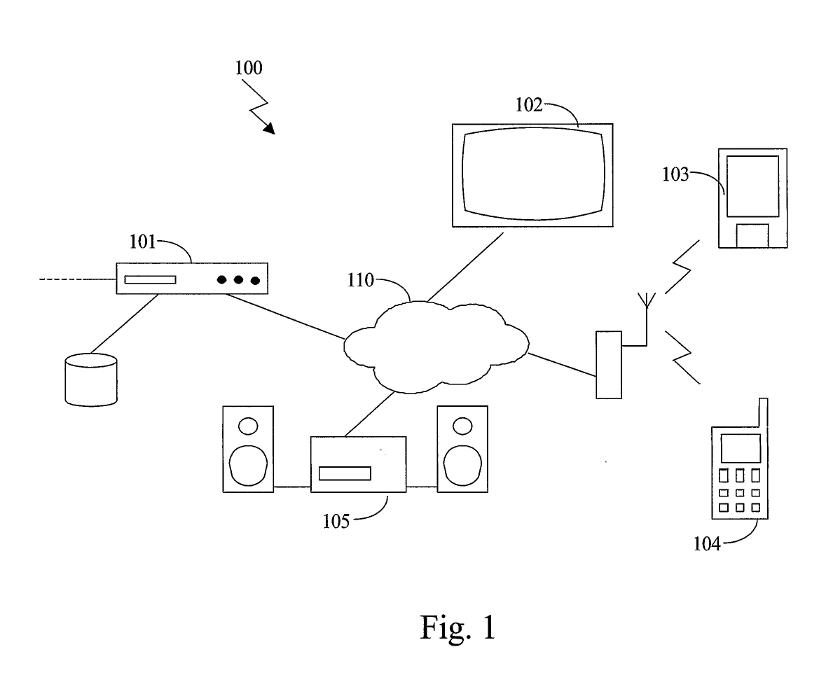

FIG. 1 schematically shows a system 100 comprising devices 101-105 interconnected via a network 110 and constituting an Authorized Domain (AD). In this embodiment, the system/AD 100 is an in-home network. Such a digital home network typically includes a number of devices, e.g. a radio receiver, a tuner/decoder, a CD player, a pair of speakers, a mobile phone, a television, a VCR, a tape deck, and so on. These devices are usually interconnected to allow one device, e.g. the television, to control another, e.g. the VCR.

Content, which typically comprises things like music, songs, movies, TV programs, pictures, games, books and the likes, but which also may include interactive services, is received through a residential gateway or set top box 101. Content could also enter the home via other sources, such as storage media like discs or using portable devices. The source could be a connection to a broadband cable network, an Internet connection, a satellite downlink and so on. The content can then be transferred over the network 110 to a sink for rendering. A sink can be, for instance, the television display 102, the portable display device 103, the mobile phone 104 and/or the audio playback device 105.

The exact way in which a content item is rendered depends on the type of device and the type of content. For instance, in a radio receiver, rendering comprises generating audio signals and feeding them to loudspeakers. For a television receiver, rendering generally comprises generating audio and video signals and feeding those to a display screen and loudspeakers. For other types of content a similar appropriate action must be taken. Rendering may also include operations such as decrypting or descrambling a received signal, synchronizing audio and video signals and so on.

The set top box 101, or any other device in the system 100, may comprise a storage medium S1 such as a suitably large hard disk, allowing the recording and later playback of received content. The storage medium S1 could be a Personal Digital Recorder (PDR) of some kind, for example a DVD+RW recorder, to which the set top box 101 is connected. Content can also enter the system 100 stored on a carrier such as a Compact Disc (CD) or Digital Versatile Disc (DVD).

The portable display device 103 and the mobile phone 104 are connected wirelessly to the network 110 using a base station 111, for example using Bluetooth or IEEE 802.11b. The other devices are connected using a conventional wired connection. To allow the devices 101-105 to interact, several interoperability standards are available, which allow different devices to exchange messages and information and to control each other. One well-known standard is the Home Audio/Video Interoperability (HAVi) standard, version 1.0 of which was published in January 2000, and which is available on the Internet at the address http://www.havi.org/. Other well-known standards are the domestic digital bus (D2B) standard, a communications protocol described in IEC 1030 and Universal Plug and Play (http://www.upnp.org).

Any two or more of these devices can be ADM capable, and any two or more of the ADM capable devices can actually act as AD Managers. The process where a device starts to act as an ADM can be performed in different ways. In accordance with one embodiment of the AD system, all devices that are provided with the capability of acting as an ADM, begin to act as ADMs as soon as they are added to the AD. It is possible that in the future every device is ADM capable. A possible alternative is that some kind of appointment is performed, i.e. at least two devices of the AD are appointed as AD Managers.

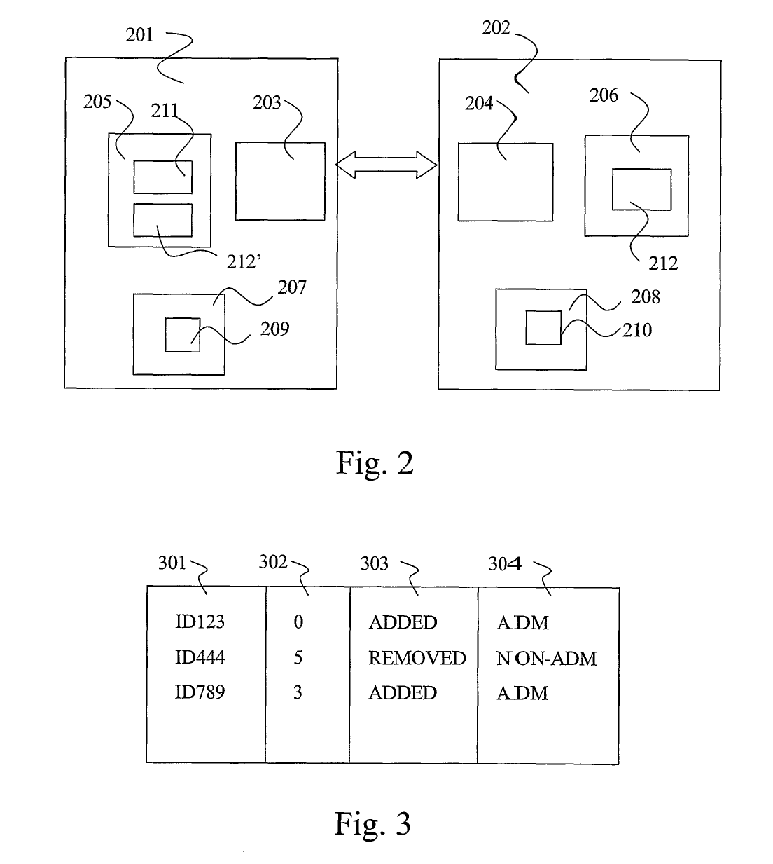

An embodiment of an ADM comprises some specific means as illustrated in FIG. 2, which means provide the device with the ADM capability. These capability providing means could be realised by means of hardware as well as by means of software added to the device In FIG. 2 there are shown two identical (first and second, respectively) ADMs 201 and 202, in order to illustrate the exchange of data between these ADMs 201, 202, as will be described below. Thus, each ADM 201/202 comprises a means 203/204 for communicating with other devices, in order to, for example, exchange map contents with other ADMs, or adding/removing a device, a memory 205/206 for storing, among other things, the map 211/212 of the ADM 201/202, a map manager 207/208 for updating the contents of the map, and a comparison means 209/210 for comparing contents of the own map with contents of another map. The ADM capability providing means are preferably arranged to store the map in a tamper-resistant way.

According to an embodiment that is illustrated in FIG. 3 the map 300 contains an identifier area 301, for identifiers corresponding to different devices, and two property areas 302, 303. The property areas 302, 303 contains properties of the identifiers. One property area is a sequence number area 302, and the other property area is a state area 303. For purposes of explanation some different fictive identifiers; ID 123, ID444, etc., are listed in the identifier area 301. The sequence number area 302 contains a list of sequence numbers, and the state area contains a list of states. Each row of the map 300 contains a sequence number and a state which are mapped to, or associated with, the identifier of that row. Each identifier identifies one device that is, or have been, a part of the AD 100. In this embodiment, there are two different states in which the device can be, i.e. added and removed, respectively.

The management of the AD is performed as follows. When a device is to be added to the AD 100 for the first time, it has to be accepted by an ADM that is currently a part of the AD. For example, a criteria to be fulfilled for an acceptance, could be that a predefined total number of devices in the AD will not be exceeded. Another criteria could be that the device meets compliance requirements. Assume, for example, that the device 101 is acting as the ADM 201, and that the device 102, which below will be referred to as the new device, is to be added to the AD 100. Let us assume that the identifier of the new device is ID555. The new device 102 will be connected to the AD 100, and the identifier ID555 of the new device will be communicated to the ADM 201. How this communication is performed will not be further described, since it can be performed in many different ways that are known to a person skilled in the art. Then, the ADM 201 will use its map manager 207 to check whether the identifier ID 555 is already present in the identifier area 301. In this case it is not, and consequently the ADM 201 will store ID555 in that area; store a sequence number of “0” in the sequence number area 302; and store a value that represents the state of “added” in the state area 303.

Assume that the other/second ADM 202 has stored the same identifier data. Now assume that the first ADM 201 is disconnected from the network, and that the new device 102 is removed during the time that the first ADM 201 remains disconnected. The second ADM 202, which is still a part of the AD 100, and which is connected to the network, will handle the removal of the new device 102, and will then shift the associated state from “added” to “removed”. According to this embodiment, the sequence number represents the number of shifts from removed to added. Consequently, the sequence number remains “0”. When the first ADM 201 is connected to the network again it will connect to the second ADM 202 at an appropriate occasion, by means of the communication means 203, in order to synchronise the contents of its map 211 with the contents of the map 212 of the second ADM 202. The first ADM 201, using its map manager 207, and the comparison means 209 thereof, will exchange map contents with the second ADM 202, and will thus store a copy 212′ of the map 212 of the second ADM 202 in its map memory 205. Then it will compare identifier data of the contents identifier by identifier. The identifier data comprises the very identifier, e.g. ID555, and property data of the properties of that identifier. If the first ADM 201 finds a discrepancy in the identifier data and determines that the identifier data of the second ADM 202 is more recently updated, it adds that updated identifier data, in case of a new identifier, or overwrites the existing identifier data for that identifier with the updated identifier data. In this embodiment, a set of conditions for when the first ADM 201 should update, i.e. overwrite contents of its own map 211 with contents from the map 212 of the second ADM 202 or add contents from the other map to its own map 211, constitutes of two conditions. A first condition thereof is that an identifier is missing in the own map 211. The identifier data of that identifier is then, of course, added to the own map 211. A second alternative condition it that the identifier is per se existing in the own map 211, but a comparison value indicates that property data regarding the identifier was last updated in the map 212 of the second ADM 202.

Thus, according to this embodiment, for each identifier, the first map manager 207 will start by comparing the sequence numbers. For the identifier ID555, the map manager 207 will note that the sequence numbers are the same (0), and will then continue by comparing the states. According to this embodiment, the states are represented by state values, where the state of “added” has a lower value than the state of “removed”. The comparison will result in a negative comparison value, i.e. the state that has been entered into the map 211 of the first ADM 201 is smaller than the state that has been entered into the map 212 of the second ADM 202. This will result in an update of the map 211 of the first ADM 201 by overwriting the data for the current state for ID555 with the state contents copied from the second ADM 202, such that the state for ID555 is shifted to “removed”.

Similarly, the map manager 208 of the second ADM 202 compares the contents of its own map 212 with the contents of the map 211 of the first ADM 201. However, for ID555 the map manager 208 of the second ADM 202 will determine a comparison value for the states which indicates that there should be no adjustment of the state data.

Now assume that the first ADM 201 is again disconnected from the AD 100, that the device 102 is added again, and that the second ADM 202 manages the adding of the device 102. Then, the map manager 208 will increment the sequence number mapped to ID555, such that the sequence number will become 1. When the first ADM 201 is then connected to the AD 100 again, and synchronises with the second ADM 202, the map manager 207 will generate a negative comparison value when comparing the sequence numbers for ID555. etc. This will result in a change of the sequence number of the map 211 into correspondence with that of the map of the second ADM 202, and a new amendment of the state, such that the state for ID555 is shifted to “added”.

Now consider a case where a device is in the state of “added” when the first ADM 201 is disconnected, and is then both removed and added again, before the first ADM 201 is reconnected to the AD 100. In this case a comparison between the maps of the first and second ADMs 201, 202 will show a difference in the sequence number, while the states are identical (added).

The conditions for the map manager operations could be described in a more mathematical and concentrated way as follows.

Let IDX represent the identifier of a device X; let SQX be the sequence number for IDX; and let STX be the state of IDX. Then, the map is: IDX→(SQX x STX). Then, IDXᵢ→(SQXᵢ x STXᵢ) represents the identifier representing the device x in the map 211 of the first ADM 201, for i=1, and in the map 212 of the second ADM 202, for i=2. Initially SQXᵢ=0 and STXᵢ=“added” in both maps 211, 212. The condition that determines a substitution of the properties of IDX₂ in the second ADM 202 for the properties of IDX₁ in the first ADM 201, is a negative comparison value, that is: (SQX₁ x STX₁)<(SQX₂ x STX₂) [symbol] SQX₁<SQX₂ OR (SQX₁=SQX₂ AND STX₁<STX₂).

In accordance with alternative embodiments of the ADM system, and the ADMs, the exchange of map contents is performed in alternative on-line or off-line ways, via a means that is external to the ADMs.

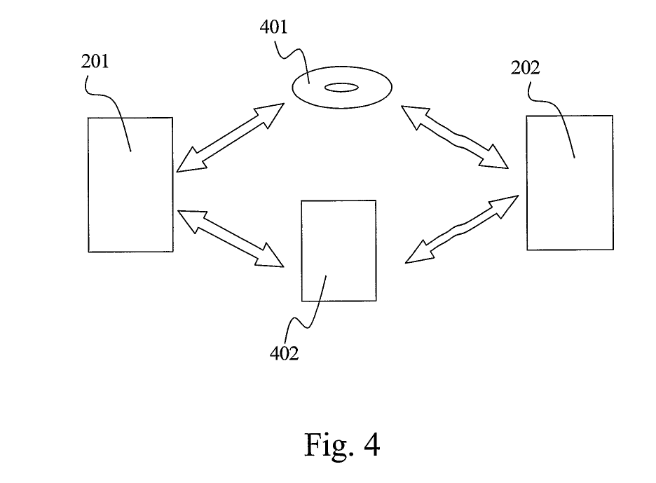

Thus, in one alternative embodiment, as shown in FIG. 4, a main version of the map is stored in a map handling device 402, which can be either a non ADM capable device or an ADM capable device, and which, for example, is used as a communication means. The ADMs 201, 202 will be connected to the map handling device 402 when connected to the network, and then the similar map exchange as between the two ADMs 201, 202, as described above, will be performed. It should be noted that security measures have been taken in order to guarantee a secure communication or authentication of the communicated data.

In another alternative embodiment, as also shown in FIG. 4, a separate, or removable, storage means 401, such as CD-R, CD-RW, DVD+RW discs, or the like, is used for each ADM 201, 202 as a storage for the map 211, 212 thereof, or as a common resource for storing a main map. In this embodiment, the synchronization is performed by each ADM either by reading map contents from the separate storage means 401, or by exchanging map contents with the separate storage means, similar to the direct exchange between the ADMs 201, 202. Similar security measures as mentioned above have been taken also in this embodiment.

In another embodiment the map 300 comprises a further property area 304 containing, for each identifier, a note regarding whether the identifier is an ADM or not. For example, this can be used for purposes of secure communication of the map contents between the devices of the AD. Thus, in order to provide for an acceptable level of security, in one embodiment, a map is stored in an attribute certificate, for example x509, which is known to the skilled person. The certificate is signed by an ADM. This means that the certificate can be stored and communicated without any further encryption proceedings. Since here are two or more ADMs 201, 202, several ADMs can sign the certificates. Each ADM will then sign the certificate with its own private key. This means that the devices are instructed to accept certificates from different ADMs. Typically, the ADM that has created the domain allows the devices to accept the different certificates. In another embodiment, the maps are encrypted with the public keys of the ADMs 201, 202. In this case, each device can only read the map of its own. When map contents are to be provided to another ADM a SAC (Secure Authenticated Channel) will be setup, for example using https. The sending device removes the encryption from the map and sends it over. The receiving device must encrypt it again with its own public key.

It is to be noted that the means described above, and in the drawings, can be separate units as well as a single processor or other unit that is able to perform the respective functions. Further, alternatively, and within the scope of the present invention, the means can be implemented as program modules of a computer program, comprising computer executable instructions for causing a computer to perform the operations that are performed by the above-described means.

Thus, in accordance with this invention, as described above, an Authorized Domain (AD) which is managed by a plurality of Authorized Domain Managers (ADMs), which are kept synchronized is provided. It is possible to temporarily disconnect an ADM from the AD, and having it correctly synchronized with an ADM that meanwhile has remained connected, and thereby has registered any changes of the other devices that are parts of the AD. This synchronization can take place either on-line or off-line, and either by direct or indirect exchange of information between the ADMs.

1-11. (canceled)

12. A device for managing an authorized domain, comprising:
means for providing a map of the authorized domain, said map including an identifier area for containing identifiers corresponding to other devices, and at least one property area for containing properties of the identifiers, said at least one property area being mapped on the identifier area such that each individual property of said properties is mapped to an individual one of said identifiers, and said properties being arranged to provide information about updates;
means for obtaining map contents of another device for managing the authorized domain; and
means for comparing the contents of the map with said map contents of said another device, and for determining, on basis of the comparison, whether to perform any updates of the map, said at least one property area including two property areas for containing two different types of properties comprised in said properties, one of said two property areas being a state area for containing states and the other one being a sequence number area for containing sequence numbers, wherein each one of said states is one of a set of at least two different types of states comprising a state of added and a state of removed, wherein each state is shiftable between said different types of states, and wherein each sequence number represents a number of shifts of an associated state from at least one of said different types of states to at least another one of said different types of states.

13. The device according to claim 12, wherein said means for obtaining map contents includes means for directly exchanging map contents with said another device.

14. The device according to claim 12, wherein said means for obtaining map contents includes means for reading a separate storage means.

15. The device according to claim 12, wherein said means for obtaining map contents is arranged for obtaining said map contents from a map handling device of the authorized domain.

16. The device according to claim 12, further comprising means for determining that property data regarding an identifier of the map of said another device should be added to the own map at fulfillment of at least one condition of a set of conditions including at least the condition of the identifier missing in the map and the combined condition of the identifier existing in the map and a comparison value, which assures that the property data regarding the identifier was last acted upon in the map of said another device, said comparison value being determined by a comparison of at least one property of said properties in the map with the corresponding property of the map of said another device.

17. The device according to claim 16, wherein said at least one property of said properties in the map comprises the sequence number, and, in case of equal sequence numbers, further comprises the state, wherein at least said state of added and said state of removed are represented by different values.

18. A system comprising:
a plurality of devices interconnectable by means of a network and being arranged as an authorized domain, wherein at least two of said plurality of devices are acting as authorized domain managers; each authorized domain manager including a device according claim 12.

19. A method for managing an authorized domain including a plurality of devices, wherein at least two devices of said plurality of devices act as authorized domain managers, said method comprising:
providing each authorized domain manager with a capability of at least managing adding devices to and removing devices from the authorized domain;
arranging a map comprising an identifier area and at least one property area;
storing identifiers corresponding to other devices in the identifier area;
storing properties of the identifiers in said at least one property area;
mapping said at least one property area on said identifier area, such that each individual property of said properties is mapped to an individual one of said identifiers;
arranging said properties so as to provide information about updates thereof;
obtaining map contents of another authorized domain manager managing the same authorised domain;
comparing the contents of the map with said map contents of said another authorized domain manager; and
determining, on basis of the comparison, whether to perform any updates of the map, wherein the determining includes determining that property data regarding an identifier of the map of said another authorized domain manager should be added to the map at fulfillment of at least one condition of a set of conditions comprising at least the condition of the identifier missing in the map and the combined condition of the identifier existing in the map and a comparison value, which assures that the property data regarding the identifier was last acted upon in the map of said another authorized domain manager; and determining said comparison value by a comparison of at least one property of said properties in the map with the corresponding property of the map of said another device.

20. A computer program product, directly loadable into the internal memory of a digital computer, comprising software code portions for causing the computer to act as an authorized domain manager, being capable of at least managing adding devices to and removing devices from an authorized domain, and for causing the computer to perform:
providing each authorized domain manager with a capability of at least managing adding devices to and removing devices from the authorized domain;
arranging a map comprising an identifier area and at least one property area;
storing identifiers corresponding to other devices in the identifier area;
storing properties of the identifiers in said at least one property area;
mapping said at least one property area on said identifier area, such that each individual property of said properties is mapped to an individual one of said identifiers;
arranging said properties so as to provide information about updates thereof;
obtaining map contents of another authorized domain manager managing the same authorised domain;
comparing the contents of the own map with said map contents of said another Authorized Domain Manager; and
determining, on basis of the comparison, whether to perform any updates of the map, wherein the determining includes determining that property data regarding an identifier of the map of said another authorized domain manager should be added to the map at fulfillment of at least one condition of a set of conditions comprising at least the condition of the identifier missing in the map and the combined condition of the identifier existing in the map and a comparison value, which assures that the property data regarding the identifier was last acted upon in the map of said another authorized domain manager; and determining said comparison value by a comparison of at least one property of said properties in the map with the corresponding property of the map of said another device.
